(19) United States
(12) Patent Application Publication
(10) Pub. No.: US 2013/0045104 A1
(43) Pub. Date: Feb. 21, 2013

(54) COMPOSITE RINGS FOR IMPELLER-SHAFT FITTING

(71) Applicants: Iacopo Giovannetti, Borgo San Lorenzo (IT); Massimo Giannozzi, Firenze (IT); Manuele Bigi, Calenzano (IT); Andrea Massini, Grosseto (IT)

(72) Inventors: Iacopo Giovannetti, Borgo San Lorenzo (IT); Massimo Giannozzi, Firenze (IT); Manuele Bigi, Calenzano (IT); Andrea Massini, Grosseto (IT)

(21) Appl. No.: 13/515,158

(22) PCT Filed: Dec. 7, 2010
(86) PCT No.: PCT/EP2010/069026

§ 371 Date: Sep. 25, 2012

(30) Foreign Application Priority Data
Dec. 11, 2009 (IT) CO2009A000064

(51) Int. Cl. F04D 29/00; F04D 29/053; B23P 15/00; F04D 29/28

(52) U.S. Cl. 416/198 A; 416/204 A; 29/889.4

(57) ABSTRACT

Systems and methods for attaching one or more impellers to a shaft and attaching composite rings to a back and front lip on each impeller to secure the impellers for high angular velocity operation. The composite rings are constructed of a material that provides a greater specific strength and greater specific stiffness relative to the material of the impellers. In multi-impeller assemblies, an impeller spacer is attached between each pair of impellers.

### CROSS REFERENCE TO RELATED APPLICATIONS

This is a national stage application under 35 U.S.C. §371(c) prior-filed, co-pending PCT patent application serial number PCT/EP2010/069026, filed on Dec. 7, 2010, which claims priority to Italian Patent Application No. CO2009A000064, filed on Dec. 11, 2009, the entire contents of which are incorporated herein by reference.

### BACKGROUND OF THE INVENTION

1. Field of the Invention

Embodiments of the present invention relate generally to compressors and, more specifically, to attaching one or more impellers to the compressor shaft with composite rings.

2. Description of the Prior Art

A compressor is a machine which accelerates compressible fluid particles, e.g., gas particles, through the use of mechanical energy. Compressors are used in a number of different applications, including operating as an initial stage of a gas turbine engine. Gas turbine engines, in turn, are themselves used in a large number of industrial processes, including power generation, natural gas liquefaction and other processes. Among the various types of compressors used in such processes and process plants are the so-called centrifugal compressors, in which mechanical energy operates on gas input to the compressor by way of centrifugal acceleration, e.g., by rotating a centrifugal impeller through which the gas is passing.

Centrifugal compressors can be fitted with a single impeller, i.e., a single stage configuration, or with a plurality of impellers in series, in which case they are frequently referred to as multistage compressors. Each of the stages of a centrifugal compressor typically includes an inlet conduit for gas to be compressed, an impeller which is capable of imparting kinetic energy to the input gas and a diffuser which converts the kinetic energy of the gas leaving the stage into pressure energy.

Increasing performance and output requirements of centrifugal compressors have resulted in increased axial rotation velocities of the impeller shafts. The greater angular velocity has exposed deficiencies in current design and assembly methods of centrifugal compressors with regard to the attachment of the one or more impellers to the shaft, which have historically been first heated to expand their attachment diameter, then mounted on the shaft and allowed to shrink and cool on the shaft to provide a tight fit thereto, i.e., heat shrinking For example, angular velocities are now reached where the difference in the radius of the impeller with respect to the radius of the axial shaft to which the impeller is mounted provides sufficient centrifugal force differential to generate failure conditions. In this regard, impeller deformation can occur to the point where the impeller slips on the shaft, resulting in a sudden drop in performance or, in a worst case scenario, a centrifugal compressor catastrophic failure.

Subsequent market pressure prompted an effort to solve this deficiency. In response, technology developed to apply a retaining ring to the back of each impeller after its attachment to the shaft. For a short time this technology proved effective but once again increasing performance and output requirements of centrifugal compressors exposed shortcomings in the technology. Greater angular velocities allowed for impeller deformation at the front of the impeller while the back of the impeller remained constrained by the retaining ring. The uneven distribution of the deformation resulted in enough force applied to the retaining ring in the axial direction of the shaft to detach the retaining ring from the impeller allowing similar failures as described above for the centrifugal compressors without the retaining ring.

Accordingly, once again market pressure is demanding methods and systems for attaching one or more impellers to a shaft in a centrifugal compressor in a manner which enables the impellers to remain attached to the shaft throughput the angular velocity operational window of the centrifugal compressor.

### BRIEF SUMMARY OF THE INVENTION

Exemplary embodiments relate to systems and methods for attaching an impeller to a shaft and attaching a composite ring to both a front and back lip of the impeller to prevent the impeller from deforming under axial rotational load. The composite rings attached to both the front and back lips of the impeller are constructed of a material of greater specific stiffness and greater specific strength than the material comprising the impeller. However, it will be appreciated by those skilled in the art that such advantages are not to be construed as limitations of the present invention except to the extent that they are explicitly recited in one or more of the appended claims.

According to an exemplary embodiment, a predetermined number of impellers are heat shrunk to a shaft with an impeller spacer placed between each pair of impellers. After attaching all required impellers to the shaft, a composite ring is attached to both a front and back lip of each impeller. In one non-limiting example, the composite rings are attached to the impellers by filament winding.

According to another exemplary embodiment, a method for attaching one or more impellers to a shaft and attaching composite rings to restrain the impellers on the shaft includes the steps of heat shrinking an impeller to the shaft, heat shrinking an impeller spacer to the shaft adjacent to the first impeller, heat shrinking a subsequent impeller to the shaft adjacent to the impeller spacer, continuing until all impellers are attached to the shaft, and attaching composite rings to the impellers in the order the impellers were attached to the shaft with the composite rings attached to the back lip then the front lip of each impeller.

### BRIEF DESCRIPTION OF THE DRAWINGS

The accompanying drawings illustrate exemplary embodiments, wherein:

FIG. 1 depicts a centrifugal compressor;

FIG. 2 is a one-half cross section of an impeller attached to a shaft with a single retaining ring;

FIG. 3 depicts a single impeller attached to a shaft with composite rings attached to the back lip and the front lip of the impeller;

FIG. 4 depicts a one-half cross section of an impeller attached to a shaft with composite rings attached to the back lip and the front lip of the impeller;

FIG. 5 depicts a one-half cross section of multiple impellers attached to a shaft with composite rings attached to the back lip and the front lip of each impeller and an impeller spacer attached between and adjacent to two impellers;

FIG. 6 depicts a method of attaching a single impeller to a shaft and attaching one composite ring to the back lip and another composite ring to the front lip of the impeller;

FIG. 7 depicts a method of attaching a plurality of impellers to a shaft and attaching one composite ring to the back lip and another composite ring to the front lip of each impeller;

FIGS. 8-10 show various stages of mounting an impeller onto a rotary shaft according to an exemplary embodiment; and

FIG. 11 shows a composite ring having a metal lining.

### DETAILED DESCRIPTION OF THE INVENTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

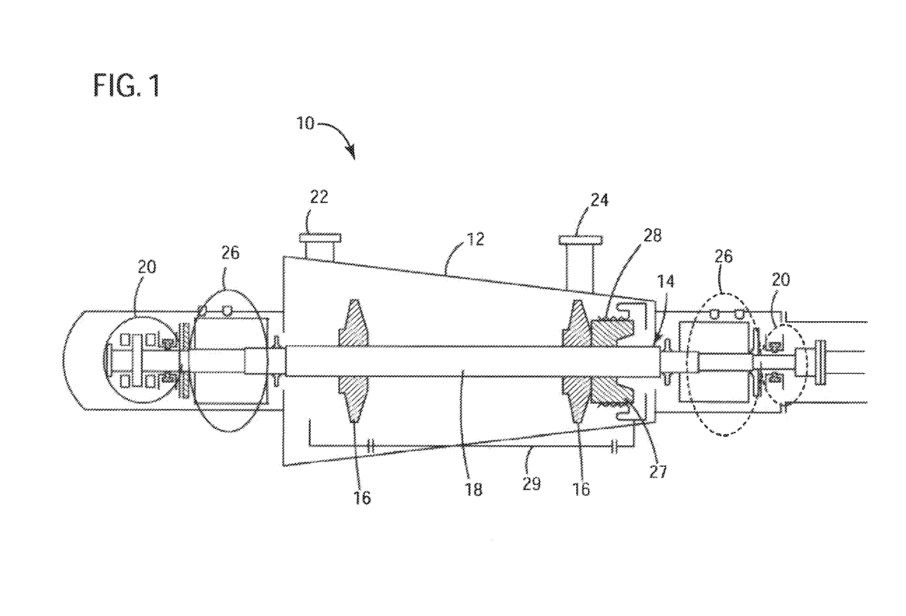

To provide context for the subsequent discussion relating to impeller attachment systems according to these exemplary embodiments, FIG. 1 schematically illustrates a multistage, centrifugal compressor 10 in which such impeller attachment may be employed. Therein, the compressor 10 includes a box or housing (stator) 12 within which is mounted a rotating compressor shaft 14 that is provided with a plurality of impellers 16. The rotor assembly 18 includes the shaft 14 and impellers 16 and is supported radially and axially through bearings 20 which are disposed on either side of the rotor assembly 18.

The multistage centrifugal compressor operates to take an input process gas from duct inlet 22 and, ultimately, to increase the process gas pressure through operation of the rotor assembly 18 by accelerating the gas particles, and to subsequently deliver the process gas through outlet duct 24 at an output pressure which is higher than its input pressure. The process gas may, for example, be any one of carbon dioxide, hydrogen sulfide, butane, methane, ethane, propane, liquefied natural gas, or a combination thereof. Between the impellers 16 and the bearings 20, sealing systems 26 are provided to prevent the process gas from flowing to the bearings 20. The housing 12 is configured so as to cover both the bearings 20 and the sealing systems 26, to prevent the escape of gas from the centrifugal compressor 10. Also seen in FIG. 1 is a balance drum 27 which compensates for axial thrust generated by the impellers 16, the balance drum's labyrinth seal 28 and a balance line 29 which maintains the pressure on the outboard side of the balance drum 27 at the same level as the pressure at which the process gas enters via duct 22.

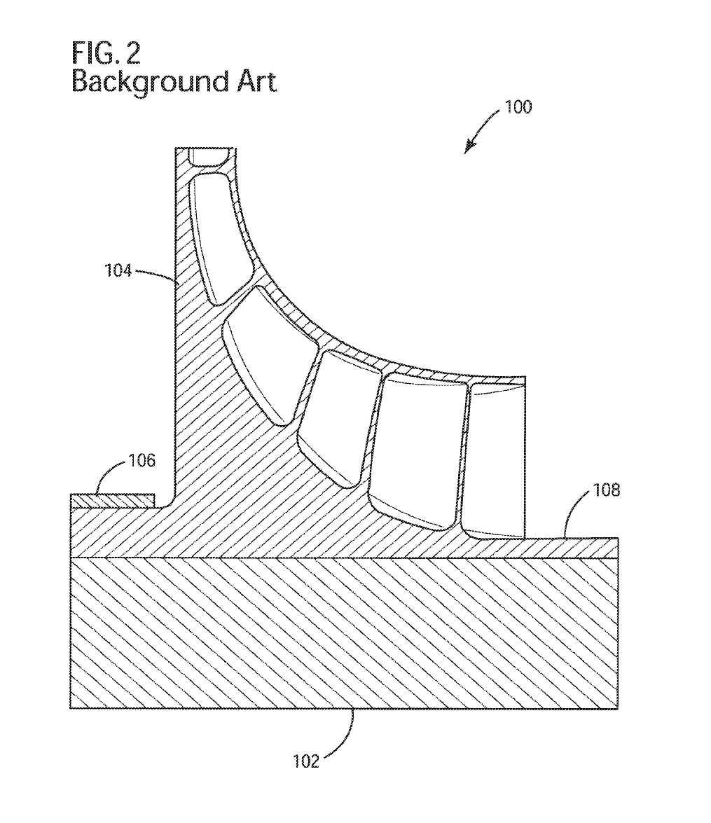

Conventionally, the impellers 16 were attached to the shaft 14 solely by heat-shrinking them thereto, as mentioned above. However another approach, is shown in FIG. 2, which schematically illustrates a one-half cross-section 100 of a single impeller 104 attached to a shaft 102 with the cross-section taken in the axial direction of the shaft 102. A single retaining ring 106 is installed on the rear lip of the impeller 104.

As discussed previously, the system described in cross-section 100 can fail in operation at high angular velocities. For example, as angular velocity is increased, a point is reached where the front lip 108 of the impeller 104 separates from the shaft 102 because of the greater centrifugal force exerted on the impeller 104 due to the greater radius of the impeller 104 with respect to the shaft 102. In contrast, the back lip of the impeller 104 is constrained by the retaining ring 106 and is therefore unable to separate from the shaft 102. The result of this uneven separation is a resultant force along the axis of the shaft 102 in a direction from the front lip 108 to the retaining ring 106 on the back of the impeller 104, detaching the retaining ring 106 from the back lip of the impeller 104 and, potentially, causing failure of the impeller/shaft assembly.

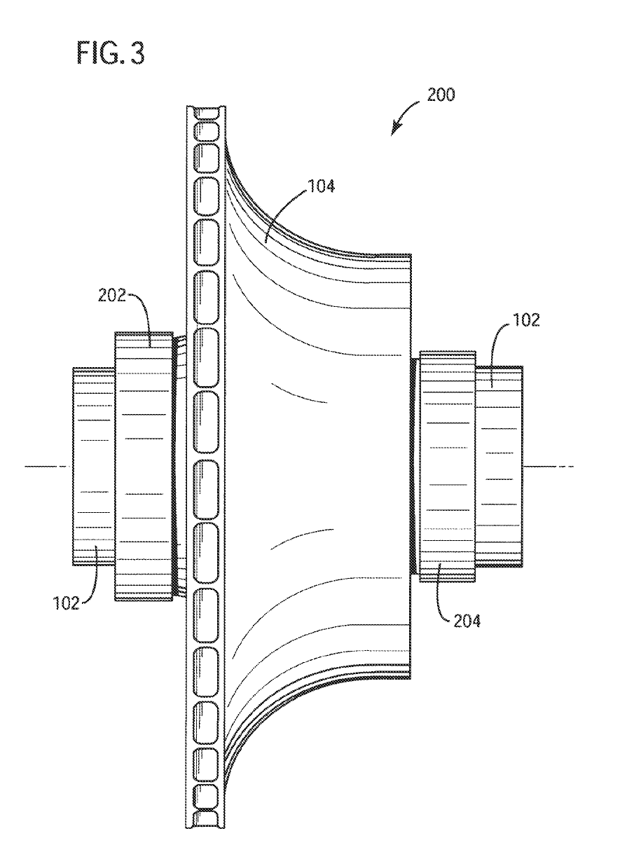

According to exemplary embodiments 200 as illustrated in FIG. 3, an impeller 104 is attached to a shaft 102. The impeller 104 can be manufactured from a material including, but not limited to, a metallic, polymeric or composite material. The impeller 104 may initially be attached to the shaft 102 by standard manufacturing techniques such as a heat shrinking process allowing the impeller 104 to be pressed onto the shaft 102 to the desired position. Further, a composite ring 202 is attached to the rear lip of the impeller 104. The composite ring 202 can be composed of for example (but not limited to) a glass fiber material or a carbon fiber material. However, the composite ring 202 is preferably created from a material with a greater specific strength and a greater specific stiffness relative to the material used in the manufacture of the impeller 104. In a similar fashion, composite ring 204 is attached to the front lip of the impeller 104, which composite ring 204 also is created from a material with a greater specific strength and a greater specific stiffness than the material used to make the impeller 104, e.g., steel. Examples of various other materials which can be used to manufacture rings 202 and 204 are provided below.

In a non-limiting example, a steel impeller 104 can be heated and pressed onto a shaft 102. A glass fiber composite material can then be attached to the rear lip of the impeller 104 creating composite ring 202. The creation of the composite ring 202 can be accomplished in a non-limiting example by a filament winding operation. In a similar manner, another composite ring 204 can be created and attached to the front lip of the impeller 104.

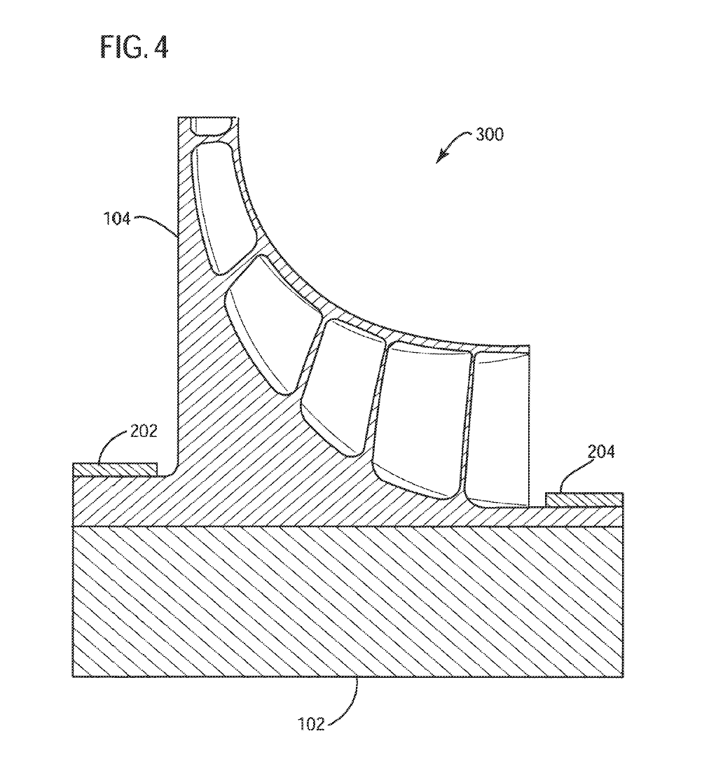

Illustrated in FIG. 4 is an impeller system 300 in a contrasting one-half cross-section view of relative to the impeller system 100 of FIG. 2. The impeller system 300 comprises an impeller 104 attached to a shaft 102 by methods previously described. Further, composite ring 202 is disposed on the back lip of the impeller 104 and composite ring 204 is disposed on the front lip of the impeller 104. The present system 300 operates to constrain the impeller 104 to the shaft 102 at positions on opposing ends of the impeller 104 along the impeller 104 axial directions via rings 202 and 204. The system 300 prevents impeller 104 deformations in a direction perpendicular to the axial direction of the shaft 102 which would otherwise be caused by centrifugal forces created by high angular velocities.

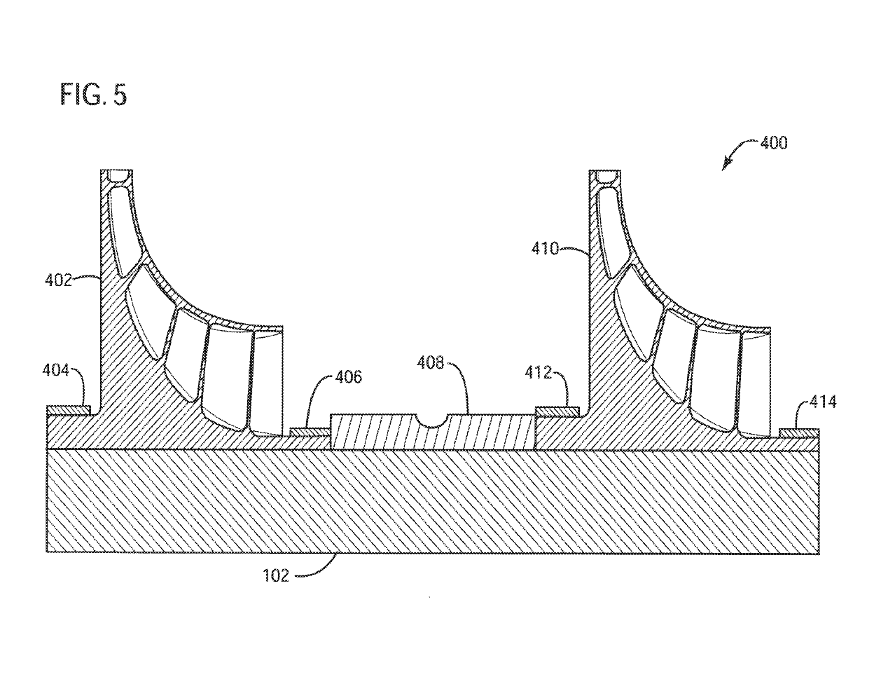

Looking now to FIG. 5, a multi-impeller system 400 according to one exemplary embodiment is illustrated in a one-half cross-section. Impeller 402 is attached to shaft 102 and composite ring 404 and composite ring 406 are attached to the back and front lips, respectively, of impeller 402. Impeller spacer 408 is attached to shaft 102 adjacent to impeller 402 to maintain a fixed and known distance between impeller 402 and a subsequently attached impeller. Impeller 410 is attached to shaft 102 adjacent to impeller spacer 408 and composite ring 412 and composite ring 414 are attached to the back and front lips, respectively, of impeller 410. It should be noted that although two impellers 402, 410 are illustrated in system 400, the number of impellers 402, 410 attached to the shaft and separated by an impeller spacer 408 are not limited, and more than two impellers may be provided.

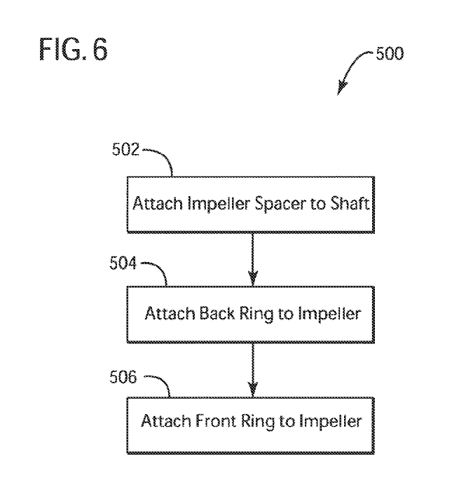

Referring to FIG. 6, a method 500 of attaching a single impeller to a shaft is illustrated. Beginning at step 502, an impeller 104 is attached to a shaft 102. In a non-limiting example, the impeller 104, with a center hole of proper diameter in relation to the shaft diameter, is heated and pressed onto the shaft 102.

Next, at step 504, a composite ring 202 is attached to the back lip of the impeller 104. In a non-limiting example, the composite ring 202 is attached to the impeller 102 by filament winding, using the resin of the winding as a bonding agent to the impeller 104. The number of windings performed is based on the material composition of the impeller 104 relative to creating a composite ring 202 with a greater specific strength and a greater specific stiffness than that of the impeller 104.

Continuing to step 506, a composite ring 204 is attached to the front lip of the impeller 104. Using the same non-limiting example as above for composite ring 202, a filament winding technique wraps the ring on the front lip of the impeller 104 using the resin of the winding as a bonding agent to the impeller 104. The number of windings performed is based on the material composition of the impeller 104 relative to creating a composite ring 204 with a greater specific strength and a greater specific stiffness than that of the impeller 104. The thickness of the composite ring 202 and composite ring 204 can be identical but are a based on the configuration of the impeller 104 and can be different if impeller 104 design factors dictate. According to some exemplary embodiments, the composite ring 202 is thicker than the composite ring 204 since the rear part of the impeller 104 is expected to have greater centrifugal force applied thereto due to its greater mass.

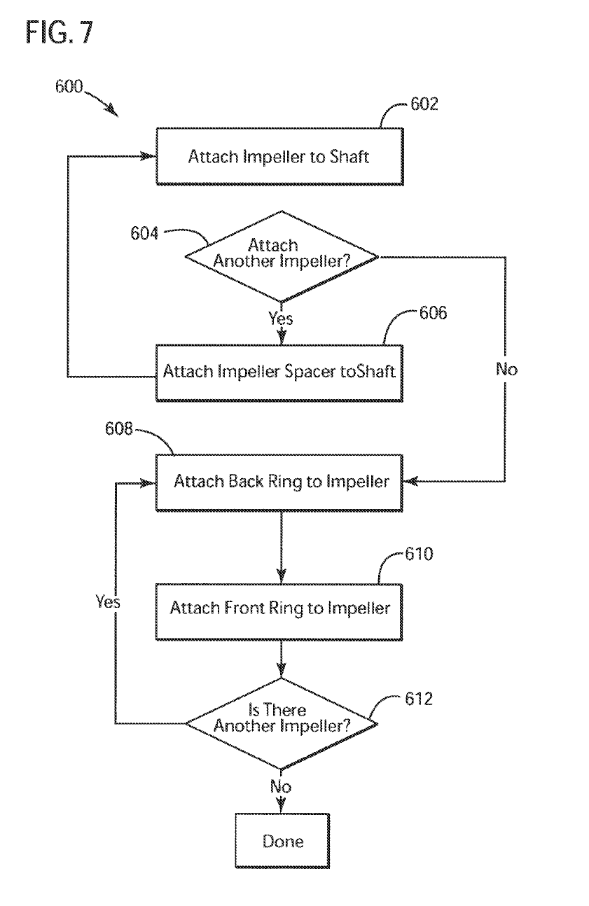

Looking now to FIG. 7, a method 600 of attaching multiple impellers to a shaft according to exemplary embodiments is illustrated. Beginning at step 602, an impeller 402 is attached to a shaft 102 by an exemplary technology as described above in method 500. Next, at step 604 a decision is made as to whether any other impellers 104 need to be installed on the shaft 102. If the application requires another impeller 104, then the method proceeds to step 606. At step 606 an impeller spacer 408 is attached to the shaft 102. The impeller spacer 408, installed by the same method used to install the impeller 104, is sized, in terms of the impeller 104 thickness and width, based on the design of the impeller 104 and/or the centrifugal compressor. The method then returns to step 602 and attaches another impeller 410 to the shaft 102. This process of alternating attachment of impeller 104 and impeller spacer 408 is continued until all required impellers 104 are attached.

Continuing after installing the last impeller 410, the method proceeds to step 608 and a composite ring 404 is attached to the back lip of the first attached impeller 402. The composite ring 404 is attached to the back lip of the first attached impeller 402 by an exemplary technology as described above in method 500. The composition and dimensions of the composite ring 404 are determined based on the construction of the impeller 402 and the operational characteristics of the centrifugal compressor.

Next, at step 610, the method attaches a composite ring 406 to the front lip of the first impeller 402 attached to shaft 102. The composite ring 406 is attached to the front lip of impeller 402 by the same exemplary technology described above to attach composite ring 404 to the back lip of the impeller 402. As described previously, the dimensions of the composite ring 404 and composite ring 406 are not required to be identical and are dictated by impeller 402 design and centrifugal compressor operating characteristics.

Continuing at step 612, a decision is made as to whether additional attached impellers 410 require attachment of composite rings 412, 414. If attachment of additional composite rings 412, 414 is required, then method 600 returns to step 608 and attaches a composite ring 412 to the back lip of the next impeller 410. Next the method 600 proceeds to step 610 and attaches a composite ring 414 to the front lip of impeller 410. This method continues attaching first the composite ring 202 to the back lip then the composite ring 204 to the front lip of each impeller 104 in the order the impellers 104 were attached to the shaft 102. It should be noted that in addition to the possibility that composite ring dimensions can vary between the two composite rings 202, 204 on a single impeller 104, the composite ring 202, 204 dimensions between composite rings 202, 204 on different impellers can also vary with regard to composition and dimension.

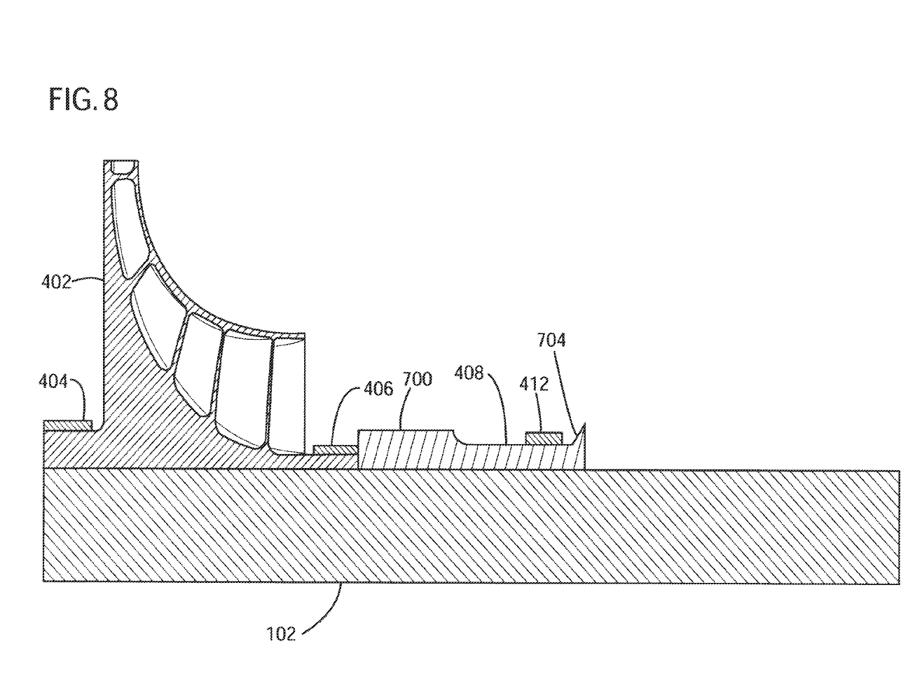

According to another exemplary embodiment, front and back rings can be installed on multiple impellers as illustrated in FIGS. 8-10 in order to further secure impellers to their shaft. In FIG. 8, a first impeller 402 is initially secured to the shaft 102 in the manner described above. Since the manufacturer has access to both sides of the impeller 402 at this time (i.e., since no other impellers have yet been installed), the composite rings 404 and 406 may be attached to the back and front lips of the impeller 402 in, for example, the manner described above. Before mounting a second impeller 410 onto the shaft 102, a composite ring 412 can first be mounted on the impeller spacer 700. In this exemplary embodiment, a portion 702 of the impeller spacer 700 has a reduced diameter such that the inner diameter of the composite ring 412 is slightly larger than the outer diameter of the portion 702 of the impeller space 702. A ramp portion 704 can also be formed in the spacer 700 to the right of where the composite ring 412 is mounted, whose function will be explained shortly.

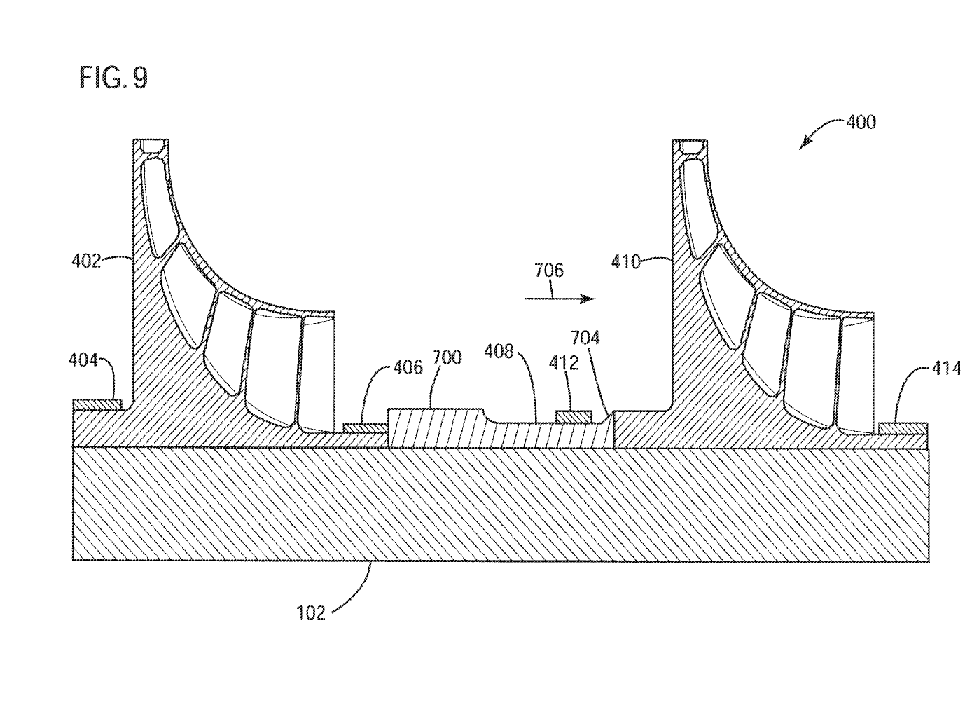

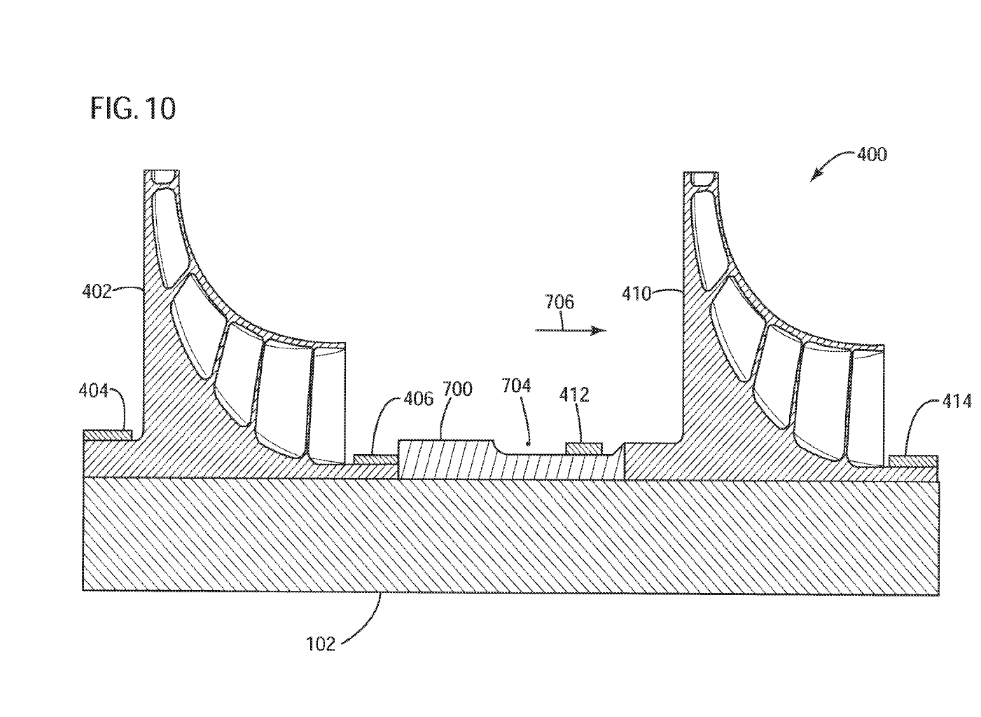

The next impeller 410 can then be mounted onto the shaft, e.g., heat shrunk thereto as shown in FIG. 9. Once cooled, the composite ring 412 can be slid along the surface of the impeller space 700, up the ramp portion 704 and onto the back lip of the impeller 410, as represented by the arrow 706 and FIG. 10 which shows the composite ring 412 in its final position. In this way, it is possible to use a composite ring 412 that is manufactured before assembly of the impeller 410 to the shaft 102 to secure the impeller 410 to the shaft 102, rather than manufacturing the ring 412 after the impeller 410 is attached to the shaft 102. Note that although FIG. 9 shows the front lip's composite ring 414 mounted prior to sliding the back lip's composite ring 412 up the ramp 704, that this process can also be performed in the reverse order.

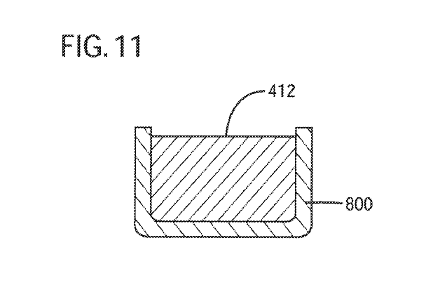

According to some exemplary embodiments, the composite rings 404, 406, 412 and 414 are applied directly to the (metal) impeller 402, 410. However, since the composite rings 404, 406, 412, 414 may be relatively flexible, it may be desirable to protect these rings, as shown in FIG. 11, by providing a metal lining or cage 800 around the composite ring 412 to protect it against the pressure used to press it against the back lip of the impeller 410, e.g., after it is slid up the ramp 704.

It shall be understood that, in this description and in the attached claims, the term composite is used to refer to, for example, a number of one or more of a variety of different fibrous structures woven into a pattern, such as a braid pattern, a stitched pattern, or an assembly of layers (and not woven arrangements only), which fibrous structures are encapsulated within a filling material. For example, such fibrous structures can be made by a plurality of unidirectional or multidirectional fibers, realized substantially to have a high anisotropy along at least a preferential direction. These fibers can have a substantially thread-like shape, as for example carbon fibers, glass fibers, quartz, boron, basalt, polymeric (such as aromatic polyamide or extended-chain polyethylene) polyethylene, ceramics (such as silicon carbide or alumina) or others. The previous description does not, however, exclude alternatives, e.g., that these fibrous structures could be realized with two or more layers of fibers, with a combination of fibers of different types or with different types of elements, as for example with granular, lamellar or spheroidal elements or woven, stitched, braided, non-crimp or other fabrics, unidirectional tapes or tows, or any other fiber architectures.

The fibrous structure(s) can be carried within a filling material which is able to, for example, hold together, evenly distribute the tensions inside, and provide resistance to high temperatures and wear for the fibrous structures during operation of the impeller which they are securing to a rotary shaft. Moreover, the filling material can be arranged to present a low specific mass or density in order to reduce the weight of the impeller and thus the centrifugal force generated during the work. The filling material could, for example, be an organic, natural or synthetic polymer material, whose main components are polymers with high molecular weight molecules, and which are formed by a large number of basic units (monomers) joined together by chemical bonds. Structurally, these molecules may be formed from linear or branched chains, tangled with each other, or three-dimensional lattices, and mainly composed of carbon and hydrogen atoms and, in some cases, oxygen, nitrogen, chlorine, silicon, fluorine, sulfur, or others. One or more auxiliary compounds can also be added to the polymer materials, such as micro- or nanoparticles, which have different functions depending on the specific needs, for example to strengthen, toughen, stabilize, preserve, liquefy, color, bleach, or protect the polymer from oxidation.

According to some exemplary embodiments, the polymer filling material of the composite rings can be constituted, at least in part, from a thermoplastic polymer such as PPS (polyphenylene sulphides), PA (polyamide or nylon), PMMA (or acrylic), LCP (liquid crystal polymer), POM (acetal), PAI (polyamide imide), PEEK (poly-ether-ether-ketone), PEKK (poly-ether-ketone-ketone), PAEK (poly-aryl-ether-ketone) , PET (Polyethylene tereptalato), PC (polycarbonate), PE (polyethylene), PEI (Poly-ether-imide), PES (polyether), PPA (poliptalamide), PVC (polyvinyl chloride), PU (polyurethane), PP (polypropylene), PS (polystyrene), PPO (polifenilene oxide), PI (polyimide; exist as thermosetting), or more. In one embodiment, for particularly high temperature various polyimides such as polymerized monomeric reactant (PMR) resins, 6F-Polyimides with a phenylethynyl endcap (HFPE), and phenylethynyl-terminated imide (PETI) oligomers may be applied.

According to other exemplary embodiments, he polymer filling material is at least partly constituted of a thermosetting polymer, such as Epoxy, phenolic, polyester, vinylester, Amin, furans, PI (exist also as thermoplastic material), BMI (Bismaleimides), CE (cyanate ester), Pthalanonitrile, benzoxazines or more. For particularly high temperature applications various thermosetting polyimides such as polymerized monomeric reactant (PMR) resins, 6F-Polyimides with a phenylethynyl endcap (HFPE), and phenylethynyl-terminated imide (PETI) oligomers may be preferred. According to other exemplary embodiments, the filling material is composed of a ceramic material (such as silicon carbide or alumina or other) or even, at least in part, from a metal (such as aluminum, titanium, magnesium, nickel, copper or their alloys), carbon (as in the case of carbon-carbon composites), or others.

Additionally, although the exemplary embodiments described above refer to attaching the composite rings to the lips of the impellers by way of filament winding, other techniques can be used in addition to, or as alternatives to filament winding including, but not limited to, thermoplastic fiber placement (TFP), automated fiber placement (AFP), resin transfer molding (RTM), and vacuum assisted resin transfer molding (VARTM).

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A centrifugal compressor impeller system, comprising:
a shaft having at least one impeller attached thereto;
a first composite ring attached to a lip at the back of each of the at least one impellers for securing the back of each of the at least one impellers to the shaft; and
a second composite ring attached to a lip at the front of each of the at least one impellers for securing the front of each of the at least one impeller to the shaft.

2. The centrifugal compressor impeller system of claim 1, further comprising:
at least one impeller spacer for maintaining a prescribed distance between at least two impellers.

3. The centrifugal compressor impeller system of claim 1 or claim 2, wherein the composite ring is comprised of at least one type of glass fiber or carbon fiber and a polymer.

4. The centrifugal compressor impeller system of any preceding claim wherein the composite ring attached to the lip at the back of each of the at least one impeller and the composite ring attached to the lip at the front of each of the at least one impeller has a greater specific strength and a greater specific stiffness than each of the at least one impellers to which said rings are attached.

5. The centrifugal compressor impeller system of any preceding claim, wherein at least one of said first composite ring and said second composite ring have a metal lining on an outer surface thereof.

6. A method for creating a single impeller system for use in a centrifugal compressor, the method comprising:
attaching an impeller to a shaft;
attaching a first composite ring to a lip on the back of the impeller to secure a back portion of said impeller to said shaft; and
attaching a second composite ring to a lip on the front of the impeller to secure a front portion of said impeller to said shaft.

7. The method of claim 6, wherein the first composite ring and the second composite ring are attached by filament winding.

8. The method of claim 6 or claim 7, wherein the step of attaching the first composite ring further comprises the step of:
sliding the first composite ring from an impeller spacer onto said lip on the back of said impeller.

9. A method for creating a multi-impeller system for use in a centrifugal compressor, the method comprising:
attaching a first impeller to a shaft;
attaching a plurality of ordered pairs of an impeller spacer then an impeller to the shaft; and
attaching a plurality of ordered pairs of a first composite ring to a lip on the back of the first impeller and then a second composite ring to a lip on the front of the first impeller and repeating this process for each impeller in the order the plurality of impellers were attached to the shaft.

10. The method of claim 9, wherein said step of attaching a plurality of ordered pairs of a first composite ring to a lip on the back of the first impeller and then a second composite ring to a lip on the front of the first impeller, further comprises:
sliding the first composite ring from an impeller spacer onto said lip on the back of said impeller.
